(19) United States
(12) Patent Application Publication
(10) Pub. No.: US 2026/0059213 A1
(43) Pub. Date: Feb. 26, 2026

(54) STEERING OF BANDWIDTH BASED UPON TEMPORAL USAGE

(71) Applicant: ARRIS Enterprises LLC, Horsham, PA (US)

(72) Inventors: David BOWLER, Stow, MA (US); Shawn W. WARNER, Pepperell, MA (US); Bruce C. PRATT, Bedford, NH (US)

(73) Assignee: ARRIS Enterprises LLC, Horsham, PA (US)

(21) Appl. No.: 19/104,158

(22) PCT Filed: May 17, 2023
(86) PCT No.: PCT/US2023/022585

§ 371 Date: Feb. 14, 2025

Related U.S. Application Data
(60) Provisional application No. 63/398,165, filed on Aug. 15, 2022.

(51) Int. Cl. H04Q 11/00

(52) U.S. Cl. CPC H04Q 11/0067; H04Q 2011/0086

(57) ABSTRACT

A system that steers the bandwidth allocation for ONTs based upon temporal usage of bandwidth.

### CROSS REFERENCE TO RELATED APPLICATIONS

The present application claims the benefit of U.S. Provisional Patent Application Ser. No. 63/398,165 filed Aug. 15, 2022.

### BACKGROUND

The subject matter of this application relates to temporal bandwidth modification.

A passive optical network (PON) is often employed as an access network, or a portion of a larger communication network. The communication network typically has a high-capacity core portion where data or other information associated with telephone calls, digital television, and Internet communications is carried substantial distances. The core portion may have the capability to interact with other networks to complete the transmission of telephone calls, digital television, and Internet communications. In this manner, the core portion in combination with the passive optical network enables communications to and communications from subscribers (or otherwise devices associated with a subscriber, customer, business, or otherwise).

The access network of the communication network extends from the core portion of the network to individual subscribers, such as those associated with a particular residence location (e.g., business location). The access network may be wireless access, such as a cellular network, or a fixed access, such as a passive optical network or a cable network.

Referring to FIG. 1, in a PON 10, a set of optical fibers and passive interconnecting devices are used for most or all of the communications through the extent of the access network. A set of one or more optical network terminals (ONTs) 11 are devices that are typically positioned at a subscriber's residence location (e.g., or business location). The term “ONT” includes what is also referred to as an optical network unit (ONU). There may be any number of ONTs associated with a single optical splitter 12. By way of example, 32 or 64 ONTs are often associated with the single network optical splitter 12. The optical splitter 12 is interconnected with the respective ONTs 11 by a respective optical fiber 13, or otherwise a respective fiber within an optical fiber cable. Selected ONTs may be removed and/or added to the access network associated with the optical splitter 12, as desired. There may be multiple optical splitters 12 that are arranged in a cascaded arrangement.

The optical fibers 13 interconnecting the optical splitter 12 and the ONTs 11 act as access (or “drop”) fibers. The optical splitter 12 is typically located in a street cabinet or other structure where one or more optical splitters 12 are located, each of which are serving their respective set of ONTs. In some cases, an ONT may service a plurality of subscribers, such as those within a multiple dwelling unit (e.g., apartment building). In this manner, the PON may be considered a point to multipoint topology in which a single optical fiber serves multiple endpoints by using passive fiber optic splitters to divide the fiber bandwidth among the endpoints.

An optical line terminal (OLT) 14 is located at the central office where it interfaces directly or indirectly with a core network 15. An interface 16 between the OLT 14 and the core network 15 may be one or more optical fibers, or any other type of communication medium. The OLT 14 forms optical signals for transmission downstream to the ONTs 11 through a feeder optical fiber 17, and receives optical signals from the ONTs 11 through the feeder optical fiber 17. The optical splitter 12 is typically a passive device that distributes the signal received from the OLT 14 to the ONTs 11. Similarly, the optical splitter 12 receives optical signals from the ONTs 11 and provides the optical signals though the feeder optical fiber 17 to the OLT 14. In this manner, the PON includes an OLT with a plurality of ONTs, which reduces the amount of fiber necessary as compared with a point-to-point architecture.

As it may be observed, an optical signal is provided to the feeder fiber 17 that includes all of the data for the ONTs 11. Accordingly, all the data being provided to each of the ONTs is provided to all the ONTs through the optical splitter 12. Each of the ONTs selects the portions of the received optical signals that are intended for that particular ONT and passes the data along to the subscriber, while discarding the remaining data. Typically, the data to the ONTs are broadcast to the feeder fiber 17 and provided to each of the ONTs.

Upstream transmissions from the ONTs 11 through the respective optical fibers 13 are typically transmitted in bursts according to a schedule provided to each ONT by the OLT. In this way, each of the ONTs 11 will transmit upstream optical data at different times. In some embodiments, the upstream and downstream transmissions are transmitted using different wavelengths of light so that they do not interfere with one another. In this manner, the PON may take advantage of wavelength-division multiplexing, using one wavelength for downstream traffic and another wavelength for upstream traffic on a single mode fiber.

The schedule from the OLT allocates upstream bandwidth to the ONTs. Since the optical distribution network is shared, the ONT upstream transmission would likely collide if they were transmitted at random times. The ONTs typically lie at varying distances from the OLT and/or the optical splitter, resulting in a different transmission delay from each ONT. The OLT measures the delay and sets a register in each ONT to equalize its delay with respect to the other ONTs associated with the OLT. Once the delays have been accounted for, the OLT transmits so-called grants in the form of grant maps to the individual ONTs. A grant map is a permission to use a defined interval of time for upstream transmission. The grant map is dynamically recalculated periodically, such as for each frame. The grant map allocates bandwidth to all the ONTs, such that each ONT receives timely bandwidth allocation for its service needs. Much of the data traffic, such as browsing websites, tends to have bursts and tends to be highly variable over time. By way of a dynamic bandwidth allocation (DBA) among the different ONTs, a PON can be oversubscribed for upstream traffic.

### BRIEF DESCRIPTION OF THE DRAWINGS

For a better understanding of the invention, and to show how the same may be carried into effect, reference will now be made, by way of example, to the accompanying drawings, in which:

FIG. 1 illustrates a network that includes a passive optical network.

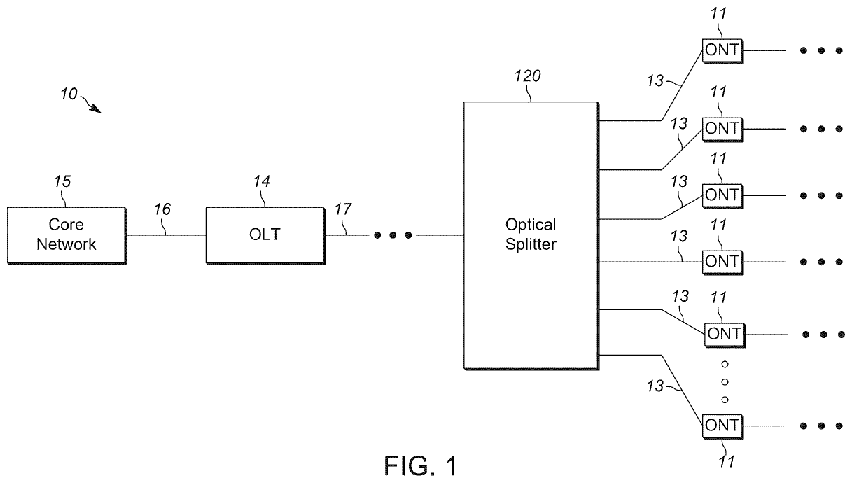

FIG. 2 illustrates dynamic bandwidth allocation.

FIG. 3 illustrates a PON network using multiple wavelengths.

FIG. 4 illustrates an ONT.

FIG. 5 illustrates an OLT.

FIG. 6 illustrates a PON system with a monitoring system.

### DETAILED DESCRIPTION

In one embodiment, the available bandwidth is allocated to each subscriber using a constant bit rate. If the subscriber needs additional bandwidth, it will not be feasible. However, using this technique most of the available bandwidth for all the subscribers will be wasted because of non-usage of allocated bandwidth by respective subscribers. This may be referred to as static bandwidth allocation. As a result of wasted bandwidth, dynamic bandwidth allocation may be used to reduce the wasted bandwidth for the subscribers as a whole and provide additional bandwidth to selected subscribers as needed.

Dynamic bandwidth allocation varies the bandwidth allocated for each subscriber according to bandwidth requests from each respective subscriber. By way of example, each subscriber of the dynamic bandwidth allocation technique may be allocated a fixed minimum bandwidth. If the subscriber is not using the allocated bandwidth, then the excess bandwidth may be taken and allocated to other subscribers based upon need. The dynamic bandwidth allocation technique may vary based upon network characteristics. In any event, the dynamic bandwidth allocation technique preferably shares the bandwidth from subscribers that are not using their allocated bandwidth, and making available that bandwidth to subscribers needing more than their allocated bandwidth.

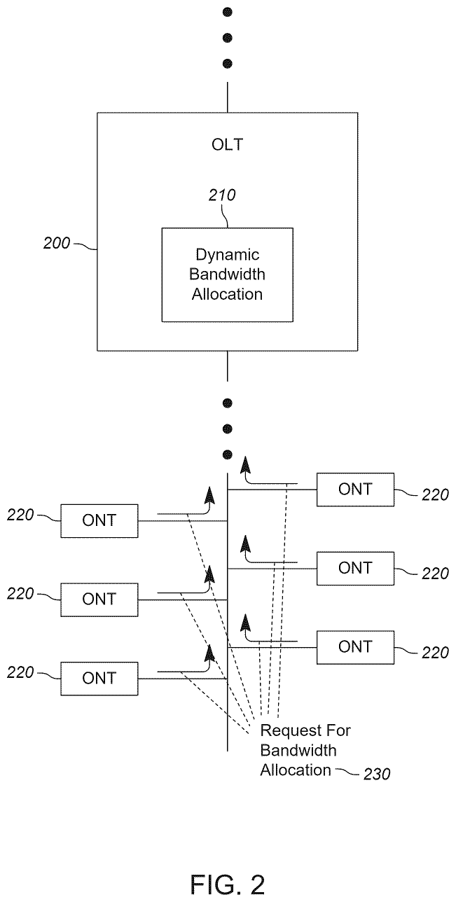

Referring to FIG. 2, an OLT 200 may include a dynamic bandwidth allocation 210 to attain a maximum usage of available network bandwidth where bandwidth is dynamically allocated to the subscribers in the network according to the needs of the subscribers, while preferably supporting a corresponding service level agreement for each respective subscriber. The needs of the subscribers are determined by the dynamic bandwidth allocation 210 by each of the ONTs 220 for the respective subscribers sending periodic requests for bandwidth allocation 230 to the OLT 200, which in response uses its dynamic bandwidth allocation 210 to allocate bandwidth to the respective ONT 220.

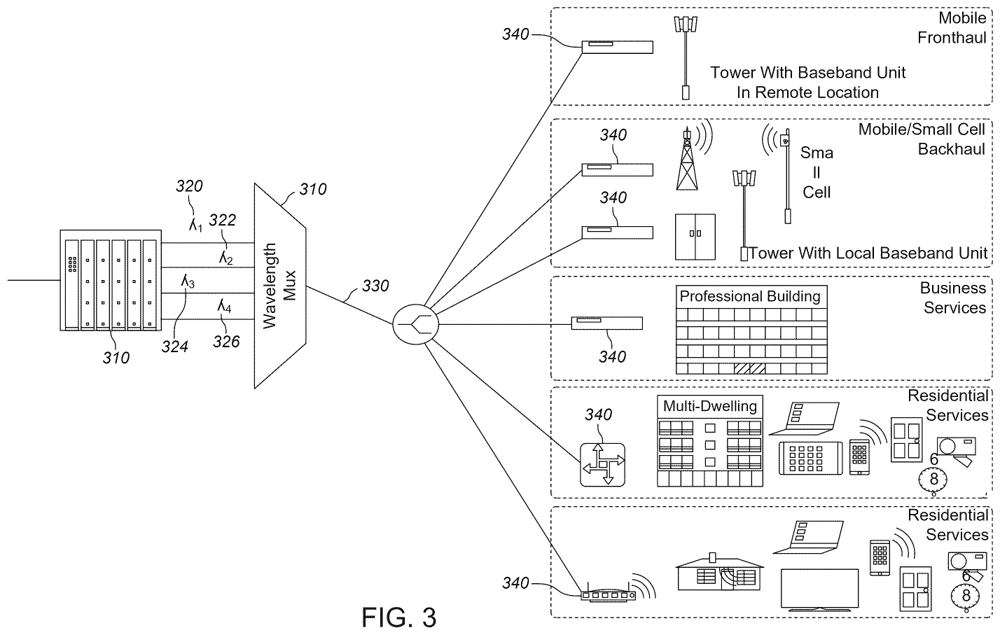

Referring to FIG. 3, the OLT 300 may be capable of transmitting data to the ONTs on the optical fiber by selectively transmitting selected data using one of a plurality of wavelengths which may be multiplexed together by a wavelength multiplexer 310. For example, a first portion of the data may be transmitted using a 1^{st} wavelength 320. For example, a second portion of the data may be transmitted using a 2^{nd} wavelength 322. For example, a third portion of the data may be transmitted using a 3^{rd} wavelength 324. For example, a fourth portion of the data may be transmitted using a 4^{th} wavelength 326. The resulting multiplexed set of wavelengths 330 is transmitted to each of the ONTs 340 of the subscribers, many of which may be different types of subscribers. Each of the wavelengths 320, 322, 324, and 326 are provided to each of the different ONTs 340 as a multiplexed set of wavelengths 330.

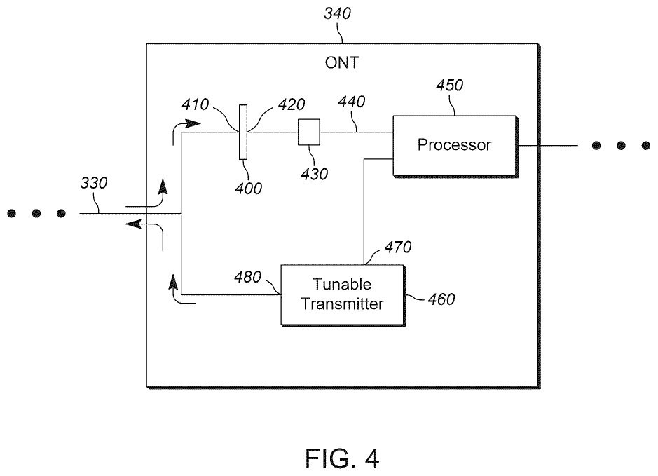

Referring also to FIG. 4, each of the ONTs 340 preferably includes a circuit topology that permits selectively selecting one of the multiplexed set of wavelengths 330. For example, the ONT 340 may include a tunable filter 400 that may be selectively tuned to one of the respective wavelengths 320, 322, 324, and 326. Preferably, the tunable filter 400 is tuned to a desired one of the respective wavelengths 320, 322, 324, and 326 based upon a temperature based adjustment mechanism. The input 410 to the tunable filter 400 is, for example, four different wavelengths each of which may include data, and the output 420 of the tunable filter 400 is a single one of the wavelengths which may include data. The output 420 of the tunable filter 400 is sensed by an optical sensor 430, such as a photodiode, to sense the data being transmitted at the selected wavelength and convert the optical signal to an electrical signal. The resulting data 440 from the optical sensor 430 is provided to a processor 450 which determines if the data is intended for the particular subscriber of the ONT. If the data is intended for the particular subscriber of the ONT, then it is processed and provided to various devices of the subscriber. If the data is not intended for the particular subscriber of the ONT, then it is discarded.

The OLT 310 may transmit control data to a respective ONT 340 to control which wavelength the tunable filter 400 is tuned to. There may be a plurality of different ONTs 340 each of which include a tunable filter that is tuned to the same wavelength. A group of the ONTs 340 may be tuned to the same wavelength, where different groups of the ONTs 340 are tuned to different wavelengths. The OLT 310 then transmits data to be processed by a set of ONTs tuned to the same wavelength, where each portion of the data is intended to be selected by one of the ONTs tuned to the same wavelength. By using a plurality of different wavelengths, the resulting downstream bandwidth of the optical network is substantially increased, albeit, with an increase in the complexity of the ONT. The distribution of the wavelengths that the tunable filters of the ONTs are tuned to may be used to even out the bandwidth allocation among the ONTs, and thus the subscribers.

It is typically considered undesirable to modify the tunable filters, other than for redistributing the bandwidth allocation of the network as subscribers are added or removed, because it takes approximately 1/10^{th} of a second to 1 second to modify the wavelength of the respective tunable filters. During the time that the tunable filter is being modified in its wavelength selection, data services are no longer available to the respective ONT.

The ONTs 340 may be capable of transmitting data to the OLT on the optical fiber by selectively transmitting selected data using one of a plurality of wavelengths which are temporally multiplexed with respect to other ONTs 340 transmitting using the same selected one of the plurality of wavelengths. For example, the ONT may transmit data using a 5^{th} wavelength. For example, the ONT may transmit data using a 6^{th} wavelength. For example, the ONT may transmit data using a 7^{th} wavelength. For example, the ONT may transmit data using an 8^{th} wavelength. The optical transmitter preferably changes its output wavelength based upon a modification of its temperature, which modifies the cavity of the optical transmitter. Other techniques may be used to modify the output wavelength of the optical transmitter.

Each of the ONTs 340 preferably includes a circuit topology that permits selectively transmitting data on one of the wavelengths. For example, the ONT 340 may include a tunable transmitter 460 that may be selectively tuned to one of the respective wavelengths 5^{th}, 6^{th}, 7^{th}, and 8^{th}. Preferably, the tunable transmitter 460 is tuned to a desired one of the respective wavelengths 5^{th}, 6^{th}, 7^{th}, and 8^{th} based upon a temperature adjustment mechanism. The output 480 of the tunable transmitter 460 is, for example, one of the four different wavelengths each of which may include data from the processor 450 provided to the input 470 of the tunable transmitter 460. The output 480 of the tunable transmitter 460 is transmitted to the corresponding OLT.

It is typically considered undesirable to modify the tunable transmitter, other than for redistributing the bandwidth allocation of the network as subscribers are added or removed, because it takes approximately 1/10^{th} of a second to 1 second to modify the wavelength of the respective tunable transmitter. During the time that tunable transmitter is being modified in its wavelength selection, data services are no longer available to the respective ONT.

A different number of downstream wavelengths may be used, as desired. A different number of upstream wavelengths may be used, as desired. Each of the wavelengths are different from one another and non-overlapping (i.e., not using the save wavelength).

As it may be observed, the ONT 340 is preferably designed such that it includes a single optical sensor 430. As it may be observed, the ONT 340 is preferably designed such that it includes a single tunable transmitter 460.

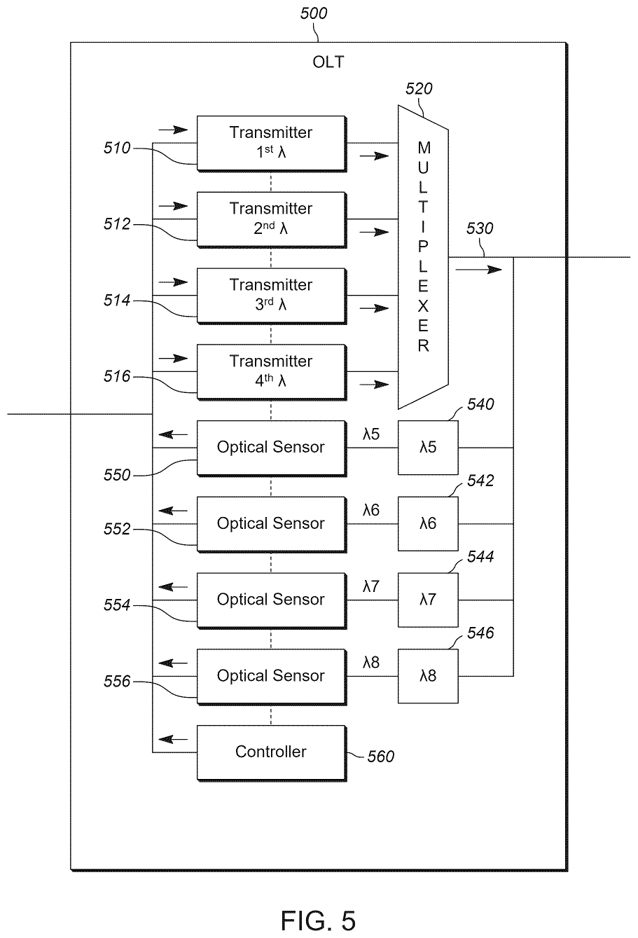

Referring to FIG. 5, an OLT 500 may include a set of four transmitters 510, 512, 514, 516 each of which is tuned to a corresponding one of the 1^{st}, 2^{nd}, 3^{rd}, and 4^{th} wavelengths. Each of the optical signals from the set of four transmitters 510, 512, 514, 516 are multiplexed together 520 onto a single optical fiber 530. A set of four filters 540, 542, 544, and 546 each of which are tuned to a corresponding one of the 5^{th}, 6^{th}, 7^{th}, and 8^{th} wavelengths may be used to pass only the corresponding wavelength to a corresponding optical sensor 550, 552, 554, and 556. Each of the corresponding optical sensors 550, 552, 554, and 556 provides a corresponding output that is time division multiplexed, under control of a controller 560, to the core network. Each of the corresponding transmitters 510, 512, 514, and 516 provides a corresponding output, under control of the controller 560, to the optical network. Other structures and configurations may be used to provide simultaneous optical signals on a plurality of different wavelengths. Other structures and configurations may be used to simultaneous receive optical signals on a plurality of different wavelengths. As it may be observed, the OLT 500 enables the simultaneous transmission of data on a plurality of different wavelengths through a single optical fiber to ONTs. As it may be observed, the OLT 500 enables the simultaneous sensing of data on a plurality of different wavelengths from a single optical fiber from the ONTs. It is noted that the optical sensors are preferably relatively wideband sensing devices, such as encompassing the range of frequencies used by the OLT that are received. The single optical fiber may be comprised of a plurality of interconnected fibers.

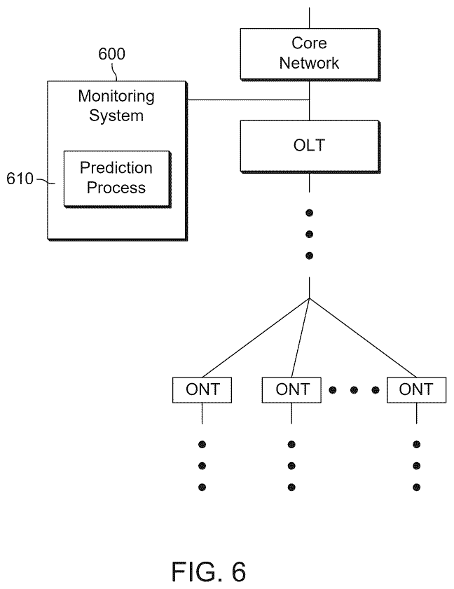

Referring to FIG. 6, a monitoring system 600 is preferably associated with the OLT and/or the core network and/or otherwise has access to the network and may be used to maintain a mapping or otherwise update a mapping for which data from the core network is to be transmitted by which of the respective transmitters 510, 512, 514, and 516 at the corresponding wavelength. The monitoring system 600 is preferably associated with the OLT and/or the core network and/or otherwise has access to the network may be used to determine which wavelength the tunable filters 420 of the respective ONTs 320 are set to. Accordingly, data for each ONT that is tuned to the 1^{st} wavelength is transmitted by the transmitter 510. Accordingly, data for each ONT that is tuned to the 2^{nd} wavelength is transmitted by the transmitter 512. Accordingly, data for each ONT that is tuned to the 3^{rd} wavelength is transmitted by the transmitter 514. Accordingly, data for each ONT that is tuned to the 4^{th} wavelength is transmitted by the transmitter 516. When it is desirable to change the group that an ONT is associated with, the monitoring system 600 signals the ONT to tune its tunable filter to a different wavelength. As previously discussed, this typically takes approximately 1/10^{th} of a second to 1 second to modify the tunable filter. After a sufficient passage of time, the monitoring system 600 signals the OLT to transmit data intended to an ONT that has changed its filtering wavelength, to the corresponding transmitter for the new wavelength. As it may be observed, the modification of the wavelengths that are used by the ONTs for the respective tunable filter 400 and the corresponding tunable transmitter 460 for the transmission of data are not suitable for a traditional bandwidth allocation technique.

After further consideration it was determined that different types of subscribers tend to have different bandwidth usage patterns. For example, a business tends to consume a substantial amount of bandwidth Monday through Friday between the hours of 8 AM and 5 PM, and during other hours the amount of bandwidth consumption is substantially reduced. For example, a residence tends to consume an insubstantial amount of bandwidth Monday through Friday between the hours of 8 AM and 5 PM, and during other hours the amount of bandwidth consumption is substantially increased. As it may be observed, depending on the time of the day, the bandwidth consumption by different classes of subscribers tends to change in a generally predictable manner. As it may be observed, depending on the day of the week, the bandwidth consumption by different classes of subscribers tends to change in a generally predictable manner. With this observation, the monitoring system 600 may modify the tunable filter of selected ONTs and the selection of the corresponding transmitter of the OLT for the modified tuning filter based upon the time of the day and/or the day of the week. For example, during the daytime Monday through Friday, 3 of the 4 available wavelengths may be primarily used for business customers, while 1 of the 4 available wavelengths may be primarily used for residential customers. For example, during the evenings Monday through Friday and weekends, 3 of the 4 available wavelengths may be primarily used for residential customers, while 1 of the 4 available wavelengths may be primarily used for business customers. Other arrangements of the wavelengths may be used, as desired.

The monitoring system 600 may also further base the allocation of bandwidth among the different wavelengths and the subscribers (e.g., ONTs) based upon respective service level agreements of the subscribers. For example, residential customers tend to have a lower service level agreement that provides for lower bandwidth with less guarantees, such as “best efforts”. For example, business customers tend to have a higher service level agreement that provides for higher bandwidth with increased guarantees, such as a minimum bandwidth. For example, commercial customers tend to have an even higher service level agreement that provides for an even higher bandwidth with greater increased guarantees, such as a minimum bandwidth.

The monitoring system 600 may further base the allocation of bandwidth among the different wavelengths and subscribers based upon localized geographic events. For example, during a football game that occurs at a stadium, the bandwidth allocation may be modified for the stadium area and businesses in the general geographic area of the event to increase the available bandwidth at a time before the event and extending to a time after the event. This provides for improved service for times that are anticipated to have increased demand.

The monitoring system 600 may include a prediction process 610 that monitors the bandwidth usage of the subscribers over time, such as over hours, days, and weeks. Based upon the temporal monitoring of the bandwidth usage, the prediction process 610 may characterize the bandwidth usage of each of the subscribers over time. Based upon the characterization, the prediction process 610 may modify the allocation of bandwidth among the different wavelengths and subscribers to more effectively use the anticipated bandwidth demands. This bandwidth allocation is based upon the historical bandwidth usage of the system, as opposed to, being made in response to a bandwidth request from respective ONTs which is used for dynamic bandwidth allocations.

In general, the tunable transmitter includes all of the components used to select one of the wavelengths for transmission on the optical fiber. In general, the optical receiver includes all of the components used to select one of the wavelengths for recovering the data being received on the selected wavelength.

Moreover, each functional block or various features in each of the aforementioned embodiments may be implemented or executed by a circuitry, which is typically an integrated circuit or a plurality of integrated circuits. The circuitry designed to execute the functions described in the present specification may comprise a general-purpose processor, a digital signal processor (DSP), an application specific or general application integrated circuit (ASIC), a field programmable gate array (FPGA), or other programmable logic devices, discrete gates or transistor logic, or a discrete hardware component, or a combination thereof. The general-purpose processor may be a microprocessor, or alternatively, the processor may be a conventional processor, a controller, a microcontroller or a state machine. The general-purpose processor or each circuit described above may be configured by a digital circuit or may be configured by an analogue circuit. Further, when a technology of making into an integrated circuit superseding integrated circuits at the present time appears due to advancement of a semiconductor technology, the integrated circuit by this technology is also able to be used.

It will be appreciated that the invention is not restricted to the particular embodiment that has been described, and that variations may be made therein without departing from the scope of the invention as defined in the appended claims, as interpreted in accordance with principles of prevailing law, including the doctrine of equivalents or any other principle that enlarges the enforceable scope of a claim beyond its literal scope. Unless the context indicates otherwise, a reference in a claim to the number of instances of an element, be it a reference to one instance or more than one instance, requires at least the stated number of instances of the element but is not intended to exclude from the scope of the claim a structure or method having more instances of that element than stated. The word “comprise” or a derivative thereof, when used in a claim, is used in a nonexclusive sense that is not intended to exclude the presence of other elements or steps in a claimed structure or method.

1. A management system for a passive optical network comprising:
(a) an optical line terminal includes at least one optical transmitter that is capable of simultaneously transmitting data at a plurality of different first wavelengths on an optical fiber to a plurality of optical network terminals;
(b) said optical line terminal includes at least one optical receiver that is capable of simultaneously receiving data at a plurality of different second wavelengths from said optical fiber from said plurality of optical network terminals, where said plurality of different first wavelengths are non-overlapping with said plurality of different second wavelengths;
(c) each of said plurality of optical network terminals receiving said plurality of different first wavelengths on said optical fiber and selectively filtering said plurality of different first wavelengths so that a respective optical sensor converts data from only one of said plurality of different first wavelengths to an electrical signal;
(d) each of said plurality of optical network terminals including a tunable transmitter capable of transmitting data at each of said plurality of different second wavelengths on said optical fiber and said tunable transmitter transmitting data on only one of said plurality of different second wavelengths on said optical fiber;
(e) said management system signaling at least one of said optical network terminals to sense a different one of said at least one of said first wavelengths based upon a predictive model of bandwidth usage without receiving a request for bandwidth from said at least one of said optical network terminals.

2. The management system of claim 1 wherein said different one of said at least one of said first wavelengths is selected further based upon a service level agreement.

3. The management system of claim 1 wherein said different one of said at least one of said first wavelengths is selected further based upon a time of day.

4. The management system of claim 1 wherein said different one of said at least one of said first wavelengths is selected further based upon a day of the week.

5. The management system of claim 1 wherein said different one of said at least one of said first wavelengths is selected further based upon a type of subscriber.

6. The management system of claim 1 wherein said different one of said at least one of said first wavelengths is selected further based upon local geographic events.

7. The management system of claim 1 wherein said different one of said at least one of said first wavelengths is selected further based upon monitoring bandwidth usage by a plurality of said optical network terminals.
